(19) United States
(12) Patent Application Publication
(10) Pub. No.: US 2010/0239484 A1
(43) Pub. Date: Sep. 23, 2010

(54) Method for Refining Solar Grade (SoG) Silicon by Using Physical Metallurgy

(75) Inventor: Kongqi Ding, Wuhan East lake High-Tech Development Zo (CN)

Correspondence Address: COHEN, PONTANI, LIEBERMAN & PAVANE LLP, 551 FIFTH AVENUE, SUITE 1210, NEW YORK, NY, 10176, US

(73) Assignee: Jiawei Solar (Wuhan) Co., Ltd., Wuhan East Lake High-Tech Development Zo (CN)

(21) Appl. No.: 12/407,230

(22) Filed: Mar. 19, 2009

(51) Int. Cl. C01B 33/037

(52) U.S. Cl. 423/349

(57) ABSTRACT

The present invention discloses a method for physically refining solar grade silicon comprises: firstly, by using a vacuum induction furnace, selecting a high oxidizing crucible to avoid carbon pollution; secondly, conducting the vacuum-pumping during the heating process; thirdly, injecting a protective gas, after the smelting temperature reaches a predetermined temperature, the powerful oxidizing gas (chlorine) is injected into the bottom of the crucible; fourthly, producing chemical reaction with the powerful oxidizing gas and impurity such as Fe—Al—Ca—P—V, so that the reaction resultant is gasified, while the power oxidizing gas stirs with the metallic silicon liquation, and preserving the temperature; fifthly, injecting the refined metallic silicon into a pouring box to enter into a oriented crystallization procedure. The present invention has following advantages: being easy and convenient to be implemented, rapid heating, no pollution, and the purity of the silicon material refined by using the method in the present invention can be graded to 5N or more.

### FIELD OF THE INVENTION

The present invention relates to the field of recyclable energy sources material, more particular, to a method for refining solar grade (SoG) silicon by using physical metallurgy, in which a vacuum induction furnace is employed to directly heat the silicon raw material, and powerful oxidizing gas is blown from the bottom of the furnace so as to produce the silicon used for solar energy industry.

### BRIEF DESCRIPTION OF THE RELATED ART

Since the Kyoto Protocol is published, the whole world has a great concern on environmental protection and sustainable development. Since non-renewable energy sources such as petroleum and coal are going to run down, everybody realizes if the renewable energy source is not able to be developed as soon as possible, building a harmonious and sustainable developed society will be void. However, the conventional method for producing high purity silicon needs big investment and has great influence to the environment, the production capacity thereof is far away from the development of the solar energy photovoltaic industry. Presently, main methods for producing silicon for the solar battery are stated in order: modified Siemens arts, silane method, and fluidized bed method. It was published on May 30, 2006 that a polysilicon solar energy project was introduced by Ningdong district, Ningxia Autonomous Region. The polysilicon material is an electric material with certain purity to which a silicon-based raw material is refined after a series of physically-chemical reaction. The polysilicon material plays a very important role to serve as an intermediate product in the silicon manufacturing industry, and is a major raw material for producing polished silicon wafer, solar battery and high purity silicon products, as well as a basic raw material of the information and new energy source industry.

The polysilicon can be divided into metallurgical grade silicon, solar grade silicon and electronic grade silicon, wherein the electronic grade silicon has the highest purity, which is the super high purity at 99.999999999% (11N).

Presently, major counties in the global producing polysilicon are US, German and Japan, total production of three countries is over 90% of that of the global. Enterprises getting into the business in our country are more than 40 and total production thereof reaches 1400 tons, which amounts to only 0.4% of the global production. The demand of the global market is increased by 10%-12% per year; it reaches to 27,000 tons by 2005, and will reach to 60,000 tons by 2010. Since supply falls short of demand in the international market, the product price is caused to greatly increase; the price of the solar grade polysilicon is rapidly increased from 9 USD/Kg at year 2000 to about 80 USD/Kg at year 2005, and the price in the domestic market is reached to a high price at 100 USD/Kg.

Basis raw materials for producing the polysilicon are industry silicon, liquid chlorine and hydrogen. To produce over 3,000 tons of the polysilicon per year, 60-100 hectares of area occupation, consumptions in 3,600 tons of industry silicon, 4,800 tons of the chloroalkali, 3,900 of hydrogen, 21 hundred millions of kilowatt hours of the electricity, 600 tons/hour of circulated water are required, the total investment is 30 hundred millions and the total production value is 15-30 hundred millions.

Presently, the mature and widely used process for manufacturing the polysilicon is the so-called modified Siemens arts (trichlorosilane reduction process), that is, the industry silicon is chloridized to trichlorosilane and then is reduced to the polysilicon, which is mainly obtained the polysilicon with high purity by a complicated chemical reaction between the silicon powder and the chlorine and the hydrogen. This technical project is a mature method.

In view of the broad market prospects for polysilicon, Nanjing Mainland Industrial Investment Group Co., Ltd. (Continental Group) plans to build a polysilicon project in the western region. Continental Group was founded in 1993, is located at the national leveled Technological Development Zone in Nanjing, and is engaged in the electrical scientific application, bio-tech industry, information-based green energy, finance private investment in high-tech enterprise group. After the Continental Group visits Ningdong base by several times, it intends to build the polysilicon project at Ningdong base. On Apr. 26, 2006, three persons in management committee at Ningdong made a special trip to the Continental Group to consult with the polysilicon project. They have a deeply understanding on polysilicon through the study of polysilicon: firstly, the polysilicon project is a high-tech capital-intensive projects, and is encouraged by the state, it is also a project with relatively large energy consumption; second, the polysilicon technology is mastered by a few of companies in the world, building the polysilicon project at Ningdong base can fill the gap in the Chinese industry; third, presently, the polysilicon project has a good benefit, but once the technology is broken through, the cost competition has become a key, the investment risk is big.

At the same time, by fully promotion and introduction, the Continental Group also has a comprehensive and accurate understanding on Ningdong base, and through discussions and exchanges, two sides reach a consensus on building and investing the polysilicon project at Ningdong base. During that period, staffs in Ningdong management committee actively collect information, contact the relevant departments and leader and maintain a close liaison and communication with the Continental Group. On May 16, 2006, Standing Committee members of the regional party committee, and the Government Economic Delegation of the Yinchuan city visit the Continental Group, and carry out further exchanges and communication with the top managements of the Continental Group regarding the polysilicon project at Ningdong bases. And a framework cooperation agreement is signed with the Continental Group; also in-depth consultation and discussion are carried out. Under the agreement, the polysilicon project is introduced into Ningdong base with planning scale in 10,000 tons and total investment in 100 billion RMB; three-stage constructions are employed, the first and the second phase respectively have an annual output of 3,000 tons of high purity solar grade silicon materials, which invests about 3,000,000,000 RMB, respectively; the third phase has an annual output of 4,000 tons of high purity silicon-class semiconductor materials, which invests about 4,000,000,000 RMB. The most mature and widely-used method for polysilicon production is modified Siemens arts (trichlorosilane reduction process), that is, the industry silicon is chloridized to trichlorosilane and then is reduced to the polysilicon, which is mainly obtained the polysilicon with high purity by a complicated chemical reaction between the silicon powder and the chlorine and the hydrogen.

So far, 90% of the polysilicon in the world are produced by using such method. Recently, the silicon production technology in the domestic imported from Russia is also used by Siemens method. Now, NanBo Yichang project and Ningxia project has following problems: it needs a huge and has a long construction period investment by using the modified Siemens arts. The large-scale usage in chlorine, hydrogen has invited environment and safety problems. On the other hand, although the high purity silicon brick by using physical metallurgical method is not suitable for large-scale integrated circuits, it is suitable that the polysilicon with the purity at 5N is used in the manufacture of solar grade battery.

### SUMMARY OF INVENTION

In view of the above, the present application is made to overcome at least one aspect of the problems and defects of the prior arts.

An object of the present invention is to provide a method for refining solar grade silicon, which is easily and conveniently implemented. While the silicon raw material is prevented from being oxidized and the chemical pollution during the smelting is avoided. While stirring action of the powerful oxidizing gas, the powerful oxidizing gas is sufficiently reacted with the impurity within the silicon raw material, so that the reaction resultant is gasified so as to be refined.

In order to achieve above object, the applicant has made a plenty of experiments in the vacuum induction furnace. Under the effect of the stirring of the powerful oxidizing gas, the impurity within the silicon material is reacted with the oxidizing gas and the result in which impurity elements are reduced as expectation is occurred.

A method for refining SoG silicon includes the steps of:

A. adding metallic silicon raw material into a high purity oxide crucible by using a vacuum induction furnace (so as to avoid the pollution of carbon);

B. heating the raw material within the high purity oxide crucible, and doing the vacuum-pumping during the heating process, for example by means of a mechanical vacuum pump;

C. injecting a protective gas (nitrogen or argon gas) to avoid the silicon being oxidized during the heating process, the smelting temperature being set from 1450- to 1780° C., after the heating temperature is reached to 1600° C., the powerful oxidizing gas (such as chlorine) is injected into the bottom of the crucible;

D. producing chemical reaction with the powerful oxidizing gas and impurity, such as Fe, Al, Ca, P, V and the like, and so that the reaction resultant is gasified, while the power oxidizing gas stirs with the metallic silicon liquation, the smelting temperature is reached to the predetermined temperature (the temperatures set in step C) and preserve the temperature for 55-80 minutes (the specific time is depended on the weight of the furnace charge);

E. injecting the refined metallic silicon into a pouring box to enter into a oriented crystallization procedure after the refining process is completed.

Comparing the present invention with the prior art, advantages and effects are provided as following: being abundant in material sources, being simplified in processing method, short construction period (the construction period is required at least two years or more by employing other method) which only half year is required for completing the construction of the production line for the present invention, as well as easy operation, lower investment and fast starting.

By using the method in the present invention to refine the metallic silicon, the purity can reach above 5N. Some impurity elements are further separated out from the silicon melt of which the purity is reached above 5N during the crystallization process while in the process of slow cooling down within the orientation crystallizer. Therefore, the SoG silicon finally obtained by the applicant has a higher purity than that of the melt. The SoG silicon produced by the present method can be used for manufacturing the solar battery. Presently, the solar battery in the international market is priced from 4.5 to 5.5 USD/W, and the silicon wafer, which constitutes the main part of the production cost of the solar battery accounts for 40% of the total cost; however, the production cost of the silicon for the solar battery produced by using the method in the present invention is only 50-60% of that using the conventional method. Therefore, the production cost of the solar battery is greatly reduced and this method sets forth favorable conditions for promoting the application scope of the solar battery. This means great deals for slowing the conflict of the energy source demand, reducing the environmental influence of usage of non-renewable energy source.

### DETAILED DESCRIPTION OF THE PREFERRED EMBODIMENTS

### Embodiment 1

A method for physically refining SoG silicon, comprising:

1. Adding metallic silicon raw material into a high purity oxide crucible by using a vacuum induction furnace, the raw material can be Si-2102, Si-2105, Si-211, in which the weight percentage of the main impurities thereof include: (%)

| Fe | Al | Ca | Si |
|---|---|---|---|
| 0.20 | 0.01 | 0.02-0.10 | 99.60-99.68 |

pulverizing the metallic silicon into the furnace, and controlling the particle diameter within the range of 10 mm.

2. Heating the raw material within the high purity oxide crucible, conducting the vacuum-pumping to 5×10⁻¹ Pa after the raw material being putted into the induction furnace.

3. Blowing a protective gas (nitrogen or argon), the smelting temperature being set at 1450 or 1650 or 1670 or 1680 or 1720 or 1740 or 1760 or 1775 or 1780° C., after the heating temperature is reached to 1600° C., the powerful oxidizing gas, such as chlorine, is blown into the bottom of the crucible, at this time, continuously heating but not exceeding 1780° C., allowing it to stir with the melt, sufficiently react with the impurity elements so that the reaction resultant is gasified, so that the purpose of impurity removal is obtained.

4. Producing chemical reaction with the powerful oxidizing gas and impurity, such as Fe, Al, Ca, P, V and the like, and so that the reaction resultant is gasified, while the power oxidizing gas stirs with the metallic silicon liquation, the smelting temperature is reached to the predetermined temperature (temperatures set in step 3) and preserve the temperature for 60-70 minutes (the specific time is depended on the weight of the furnace charge), after the purity of the refined silicon is reached to 5N, the silicon liquation is injected into the orientation crystallizer. The silicon liquation within the orientation crystallizer is controlled to cool down below 50 DC with a speed at 30-33° C./hour, so that a high purity silicon ingot with the orientation crystal features is obtained.

5. Injecting the refined metallic silicon into a pouring box to enter into a oriented crystallization procedure after the refining process is completed.

6. Sampling and carrying out the chemical analysis. As a result, polysilicon with purity of 99.9996 is achieved.

### Embodiment 2

1. Adding metallic silicon raw material into a high purity oxide crucible by using a vacuum induction furnace, the raw material can be Si-311, in which the weight percentage of the main impurities thereof are: (%)

| Fe | Al | Ca | Si |
|---|---|---|---|
| 0.30 | 0.10 | 0.10 | 99.50 |

pulverizing the metallic silicon-311 into the furnace, and controlling the particle diameter within the range of 10 mm.

2. Heating the raw material within the high purity oxide crucible, vacuum-pumping to 5×10⁻¹ Pa after the raw material being putted into the induction furnace.

3. Blowing a protective gas (nitrogen or argon), the smelting temperature being set at 1450 or 1650 or 1670 or 1680 or 1720 or 1740 or 1760 or 1775 or 1780° C., after the heating temperature is reached to 1600 DC, the powerful oxidizing gas, such as chlorine, is blown into the bottom of the crucible, at this time, continuously heating but not exceeding 1780° C., allowing it to stir with the melt, sufficiently react with the impurity elements so that the reaction resultant is gasified, so that the purpose of impurity removal is obtained.

4. Producing chemical reaction with the powerful oxidizing gas and impurity, such as Fe, Al, Ca, P, V and the like, so that the reaction resultant is gasified, while the power oxidizing gas stirs with the metallic silicon liquation, the smelting temperature is reached to the predetermined temperature (temperatures set in step 3) and maintain the temperature for 60-70 minutes (the specific time is depended on the weight of the furnace charge), after the purity of the refined silicon is reached to 5N, the silicon liquation is injected into the orientation crystallizer. The silicon liquation within the orientation crystallizer is controlled to cool down to 30 or 35 or 38 or 42 or 45 or 48° C. with a speed at 30-35° C./hour, so that a high purity silicon ingot with the orientation crystal features is obtained.

5. Injecting the refined metallic silicon into a pouring box to enter into a oriented crystallization procedure after the refining process is completed.

6. Being shown from the chemical analysis, the purity of the silicon material is reached to 99.9994 through the smelting and refining.

Although a few embodiment of the present invention have been shown and described, it would be appreciated by those skilled in the art that changes may be made in these embodiments without departing from the principles and spirit of the invention, the scope of which is defined in the claims and their equivalents.

What the claim is:

1. A method for physically refining solar grade silicon, comprising:
A. adding metallic silicon raw material into a high purity oxide crucible by using a vacuum induction furnace;
B. heating the raw material within the high purity oxide crucible, conducting the vacuum-pumping during the heating process;
C. injecting a protective gas, and the smelting temperature being set from 1450- to 1780° C., after the heating temperature is reached to 1600° C., the powerful oxidizing gas is injected into the bottom of the crucible;
D. producing chemical reaction with the powerful oxidizing gas and impurity such as Fe—Al—Ca—P—V so that the reaction resultant is gasified, while the power oxidizing gas stirs with the metallic silicon liquation, the smelting temperature is reached to the predetermined temperature and maintained for 55-80 minutes;
E. injecting the refined metallic silicon into a pouring box to enter into a oriented crystallization procedure after the refining process is completed.

2. The method for physically refining solar grade silicon as set forth in claim 1, wherein the protective gas includes nitrogen or argon gas.

3. The method for physically refining solar grade silicon as set forth in claim 1, wherein the powerful oxidizing gas includes chlorine gas.

4. The method for physically refining solar grade silicon as set forth in claim 1, wherein:
the smelting temperature can be set at 1450 or 1650 or 1670 or 1680 or 1720 or 1740 or 1760 or 1775 or 1780° C.

5. The method for physically refining solar grade silicon as set forth in claim 1, wherein:
in step D, after the temperature is maintained at the predetermined temperature for 55-80 minutes, the silicon liquation within the orientation crystallizer is controlled to cool down to below 50° C. with a speed at 30-35° C./hour.

6. The method for physically refining solar grade silicon as set forth in claim 5, wherein:
in the cooling process, the silicon liquation within the orientation crystallizer is controlled to cool down to 30 or 35 or 38 or 42 or 45 or 48° C.

7. The method for physically refining solar grade silicon as set forth in claim 1, wherein:
in step A, the particle diameter of the silicon raw material is within the range of 10 mm.

8. The method for physically refining solar grade silicon as set forth in claim 1, wherein:
in step B, the induction furnace is vacuum-pumped to 5×10⁻¹ Pa after the silicon raw material being putted into the induction furnace.

9. The method for physically refining solar grade silicon as set forth in claim 1, wherein:
the impurities of the silicon raw material include Fe in the range of 0.20-0.30; Al in the range of 0.01-0.10; and Ca in the range of 0.02-0.10.

10. The method for physically refining solar grade silicon as set forth in claim 1, wherein:
in step D, the temperature is maintained at the predetermined temperature as set forth in step C for 60-70 minutes.
